(19) United States
(12) Patent Application Publication
(10) Pub. No.: US 2004/0015837 A1
(43) Pub. Date: Jan. 22, 2004

(54) Online document assembler

(76) Inventors: Steve Worthington, Auckland (NZ); Alister Gates, Auckland (NZ); Rod Gates, Auckland (NZ); David Cam, Auckland (NZ); Phil Creagh, Auckland (NZ)

Correspondence Address: JACOBSON HOLMAN PLLC, 400 SEVENTH STREET N.W., SUITE 600, WASHINGTON, DC, 20004, US

(21) Appl. No.: 09/926,185

(22) PCT Filed: Jul. 27, 2001
(86) PCT No.: PCT/NZ01/00153

(30) Foreign Application Priority Data
Jul. 27, 2000 (NZ) 506004

(51) Int. Cl. G06F 9/44

(52) U.S. Cl. 717/107; 717/100

(57) ABSTRACT

An online web-based document assembler and authoring software therefor. Authors build a library of stored document text using standard word processing software and using unique add-in software define a series of structured questions and input fields which in use are presented on web pages accessable to end users. End users requiring a document access a site containing the assembly software and by answering the questions posed and entering data unique to the document they are requesting cause a fished document to be assembled at the site which is subsequently made available to the end user in downloadable form or is emailed to an address of the user's choosing.

### TECHNICAL FIELD

This invention relates to document assembly systems and in particular, but not solely, a system which is accessed via the internet and assembles documents in response to user interaction over the internet.

### BACKGROUND ART

Document assembly systems running in conjunction with standard word processing software are well known and typically involve the production of documents by merging variable information specific to the transaction being documented with a precedent form or a series of precedent paragraphs. At a slightly higher level of sophistication the assembly system will prompt and guide the user in real time to provide appropriate variable information as the agreement is being prepared.

More sophisticated document assembly systems are “intelligent” systems which ask the user a series of questions, not only to acquire variable information, but also to select appropriate clauses for the document with the system logic causing branching to the appropriate clause or to the next question based on answers given to the previous question.

Traditionally, document assembly systems are used by lawyers or paralegals in law offices and are not suited for use by lay people. Such systems are usually run on the local area network of the law firm. It has been perceived that there is a demand for lay persons to access document assemblers to produce legal documentation appropriate to a transaction being undertaken without the need to consult a lawyer. One pseudo online system intended to meet this demand is RapidDocs™. RapidDocs™ authoring software is purchased by law firms who prepare the base forms and logic for preparing documents for transactions which reflect the particular law firm's expertise. End users acquire RapidDocs™ assembly software, which they may download over the internet, which allows them to assemble the appropriate document downloaded from the selected law firm. Documents appropriate to a users needs can be located by conducting a “Lawyer Search” which allows a search for a particular legal skill in a selected geographic area. The results provide a direct link to the RapidDocs™ documents available for downloading and purchase from the selected law firm's website.

The RapidDocs™ system has a number of disadvantages. These include the need for users to acquire and run document assembly software on their own PCS, and the need to locate a source of form documents appropriate to their transaction.

### DISCLOSURE OF INVENTION

It is an object of the present invention to provide a central document assembly system which is accessed by users over the internet and which goes at least some way towards overcoming the abovementioned disadvantages.

Accordingly in one aspect the invention consists in a document assembly system resident on a web server which allows a user with web connectivity and a browser to invoke said system and interactively assemble a document at the web server comprising:

a stored library of packets of text each relating to a different document and each document packet containing blocks of text that will meet a variety of possible contingencies for a document of that type,

means which dynamically create web pages applicable to a document which present document determining queries to the user's browser and capture decisions made by said user in response, together with unique user input data relevant only to the particular document being assembled,

means which selects from said library blocks of language based on said user decisions,

a database which stores said user data,

software that assembles said blocks of language and populates the assembled document with said user data,

and means for delivering the assembled document to said user,

In a further aspect the invention consists in authoring software for the creation of interactive web pages for a document assembly system resident on a web server comprising:

WP application software which allows the creation of standard text for each of a plurality of documents and which incorporates macros and data fields,

software which includes:

means which creates interactive web pages for said web server,

said pages constructed to in use present document determining queries to a user and capture decisions made by said user in response, together with unique user data input,

means which establish rules for the storage of said user decisions and data input,

means which generate document-specific macros and fields for document text in said WP applications and means which select and trigger appropriate macros based on decisions captured by said web pages and populates appropriate fields with user input data.

Throughout this patent specification the term “internet” includes not only the public internet but also intranets, extranets and other networks using internet protocols. Furthermore, while the preparation of legal documents is the only described application of the present document assembly system, it should be understood that the system has many other applications and can automate the production or completion of a wide variety of forms.

The present invention makes use of a standard word processor which in the preferred form is Microsoft WORD™. However, other word processor packages such as Corel Word Perfect could be used and thus the generic acronym “WP” is used in this description to designate word processor software.

### BRIEF DESCRIPTION OF THE DRAWINGS

FIG. 1 is a diagram showing the key steps and elements of the document assembly system of the present invention;

FIG. 2 is a diagram showing the steps employed in the authoring module;

FIG. 3 is a fragment of a decision tree used in authoring a commercial lease according to the present invention;

FIGS. 4 to 8 show a small selection of web pages produced from the authoring software of the present invention for the production of a commercial lease and as made available to end users accessing the site to assemble such a document, and is a representation of the document assembly software indicating presentation layer, business rules and data warehouse.

### BEST MODES FOR CARRYING OUT THE INVENTION

Overview

The present document assembly system is essentially a server side application that creates a process that allows an internet user to create a complex document through answering a menu of questions and entering data on active server pages (ASPs). It manages the front-end interface of creating and presenting the appropriate active server pages to the end user and storing the information and instructions as database tables in a database. It also handles the back-end process of creating the library of stored text, manipulating it according to the stored instructions, inserting captured data and converting it into fully formatted WP documentation which is downloaded to the user.

The back-end authoring process of creating the library of information that needs to pre-exist before the user commences creating a document, is done in WP using macros and merge fields. The coding for the web pages and the database tables to create a customised document can be generated by the system.

The document assembly system can be viewed as comprising two modules: authoring software and assembly software.

Authoring Software Overview

This module allows server side staff involved in creating original documentation and processing commands to streamline the process of coding the WP documentation with mail merge and macro instructions and to create active server pages with plain language questions that trigger these commands without the need for manual coding.

The operation will be described using the example of a document assembly service provider creating an on-line automated process for making a will.

(a) First a legal adviser creates a WP document that includes language for all the common options for that particular form of document and generates a decision tree to determine what clauses should be employed and what data should be captured depending on the end user's individual circumstances and requirements.

(b) A data entry operator opens the WP document before macros or fields have been inserted and then invokes the authoring software from an add-in menu.

(c) The data entry operator working with the lawyer enters data fields and macros to either take out blocks of text that are not applicable in the context of an individual transaction or enter data that is context specific to the transaction.

(d) A generic framework or template for a will is then created and an interview process set up on active server pages. The data entry operator is prompted as to what type of data fields needs to be attached to the interview answers (ie Free Text, Data, etc).

(e) Either a programmer manually crates the code to link the macros and fields in the core WP document with the database table in the database server or this process is carried out by the software.

(f) At this point, the web pages are plain with no formatting. A graphic designer may work on the Active Server Page code and add colours, formatting, layout, etc. Preferably these functions are performed by the software and are made available on a special purpose menu.

(g) Prompts may be entered in the template for each data field that will be displayed to the user on the web page. Typically a prompt is less than 10 words. Pull down pages containing extra help can be provided.

(h) A test is provided to test that when user completes all the required information it is sufficient to assemble a legally sound document.

Assembly Software Overview

This module merges data from the database 14 into a WP document and invokes mail merge and macros to complete a full document ready for printing. The assembly application also invokes email messages from server to user giving inductions and progress reports.

(a) The end user (in this case the person making the will) will be asked to provide through active server pages:

unique data such as names and addresses of the grantor, beneficiaries, executors, etc

decisions regarding the dispositions that the grantor wishes to make, eg for spouses, children, grandchildren, etc, and the appointment of trustees and executors which will result in various blocks of text from the core document being retained and other blocks excluded.

(b) The assembly application gathers this information from the user through active server pages and codes this data in a database table in the database server.

(c) The user web pages will, on completion of the interview process offer a button for “complete and send document”. That command will trigger a merge (assemble) of the document This process will not only merge the data from the database table but also invoke any macros that are required to be run to complete the formatting of the document.

(d) Typically the document is then saved as a WP and/or PDF file and the web user is e-mailed that their document is ready for download from the web site.

Document Assembly Software and Process

The assembly software is preferably a VB application compiled as a dll. The dll handles the following options:

(a) the pages do not exist until the user calls them, the info comes from the database and the dll extracts the information from a database and creates an xml file, which gets parsed with an xsl through an asp processor to product an html page.

(b) the pages are created by the authoring software and published as an asp page to the server.

(c) a url, or include file is created by the server.

On submission of the form the application accepts the query sting for form collection and checks to see if there is a data xml file. If there is no xml file then a new one is created. If one exists then that is opened to see if the elements already exist, if they exist then the data value is updated If they do not exist then new elements are added.

On completion of the web forms the user gets the finish page, from here the dll makes a text file from the xml file and then merges that with the WORD document.

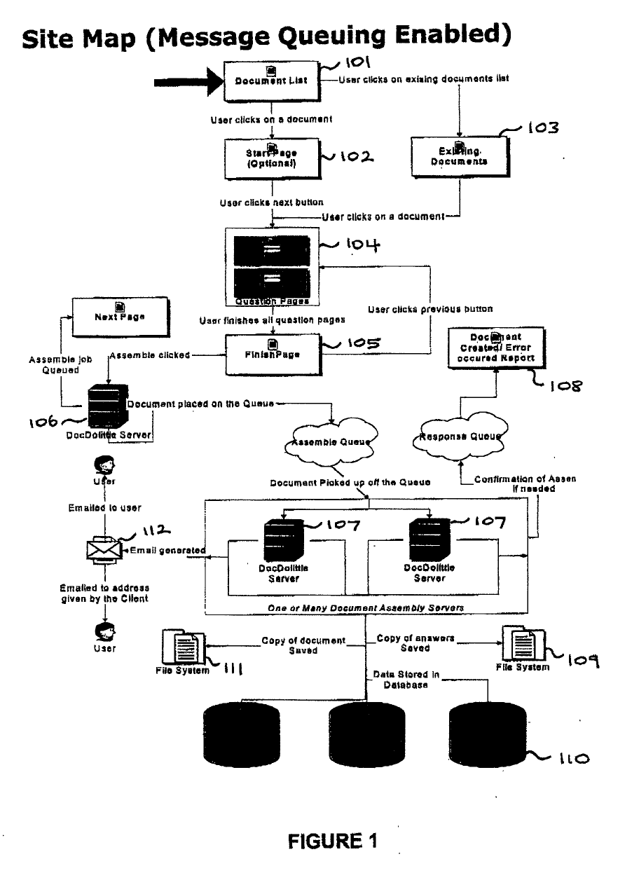

FIG. 1 outlines the essential steps which are followed when an online user requests the preparation of a document. Upon logging on to the site the user's browser is presented with a document list page 101, he selects the document required and is presented with the start page 102 for that document Alternatively the user may wish to revise a document previously prepared and is presented with the start page 103 for that document. It should be understood that what the online user sees are not pages of the document, but rather pages on the site which present and perceive information which controls the assembly of the document.

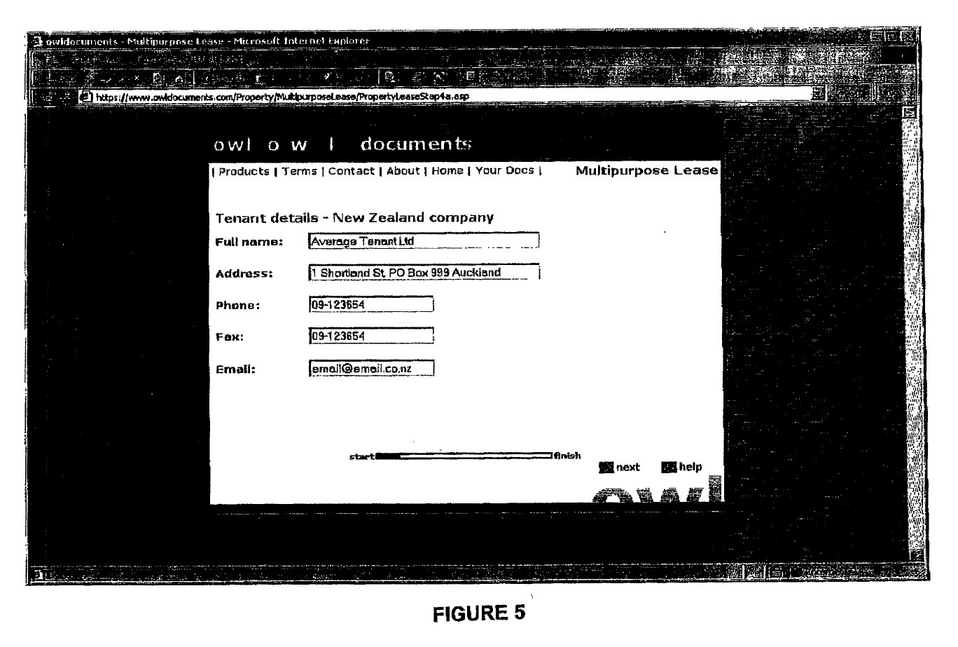

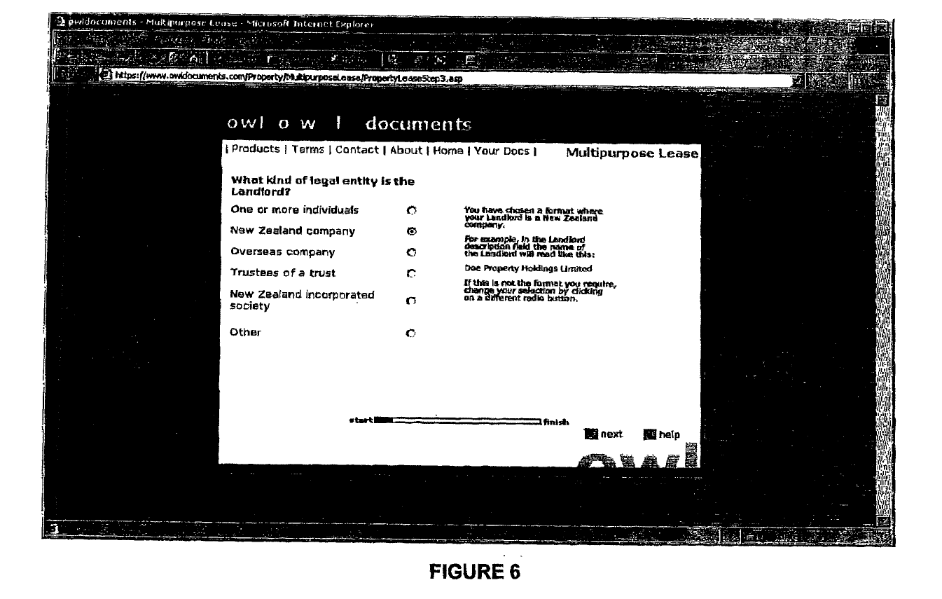

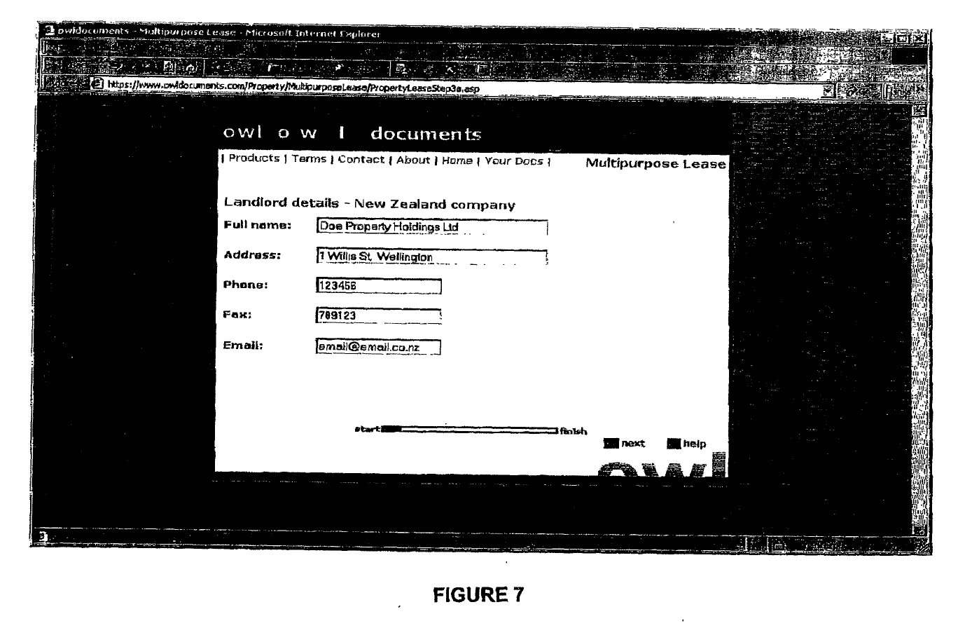

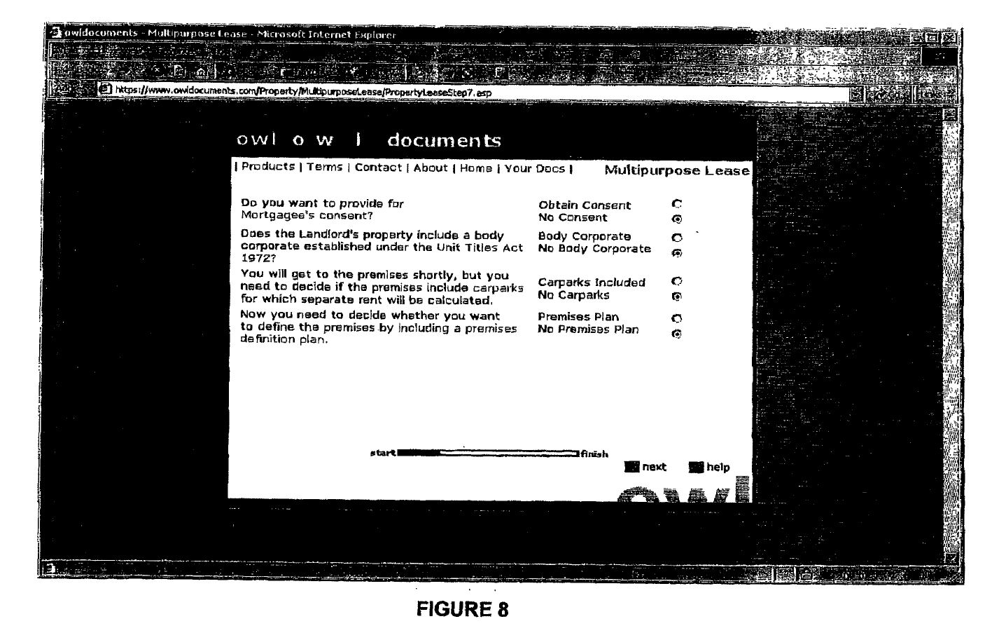

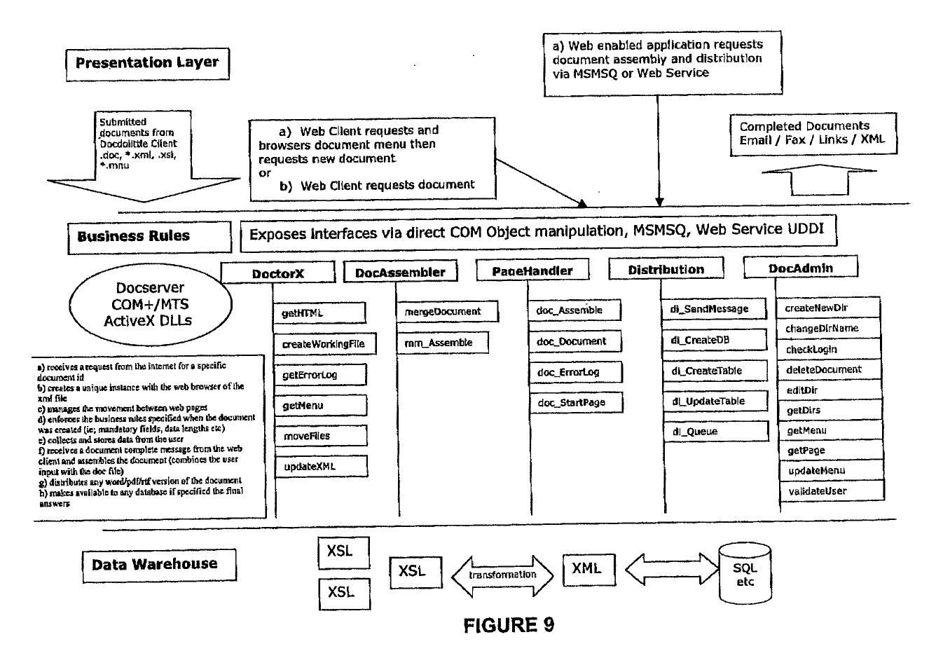

The user then enters a series of question pages 104 where questions appropriate to that particular document are asked. For example in a commercial lease there will be a page asking “What kind of legal entity is the landlord?” (see FIG. 6). This may be followed by another page which will ask “Do you want to provide for mortgagee's consent?” (see FIG. 8). There will also be pages for receiving the fill name, address, and other contact details of the parties to the agreement Examples of these are shown in FIGS. 5 and 7 and will be described later.

As each question page is answered the answers are stored at the site, preferably in the same file which carries the questions. Preferably an XML file is used. The user then is displayed with a “finish” page 105 where he will indicate that he wishes the document to be assembled or saved for completion later, Upon clicking an assemble button the XML, file with questions and answer, is passed from site server 106 to one or more document assembly servers 107. In simple sites the assembly server function may be carried out on the same hardware as the site server resides. The assembly process involves the selection of stored blocks of text, for example clauses in a legal agreement, from the totality of blocks of text in a library for that agreement. The library will be stored in a database 110. The selection is at least in part determined by the answers contained in the XML file.

In addition the variable data entered by the user is extracted from the XML file, possibly converted to a .txt file and is then merged in WORD with the selected clauses to create the assembled document 108. The user's answers are then saved in a table in a database 109 which could take any known database form. A copy of the entire assembled document 111 may also be stored in database 110. The user will have indicated at the finish page where the document is to be published to. This may be an email process 112 where the document is emailed to the address determined by the user. The format of the document emailed to the user may be a WORD document which would allow further changes by the user, or for lay users, more probably a document in PDF format. In the preferred form of the invention during the assembly process the user will not see any part of the actual document being created until it is emailed to him at the end of the process. The user may also be given the choice of downloading the document from the website.

Authoring Software and Process

The authoring software is installed on the authors computer. When the author starts up WORD then under the Tools menu he will see the menu items under the add-in software link.

The authoring software consists of one data file, either a SQL Server or MSDE file. It may also include the Microsoft Data Engine in case the author does not have an SQL Server. It will also consist of an application file that will be a compiled Visual Basic program. This will contain all the user interface and functionality.

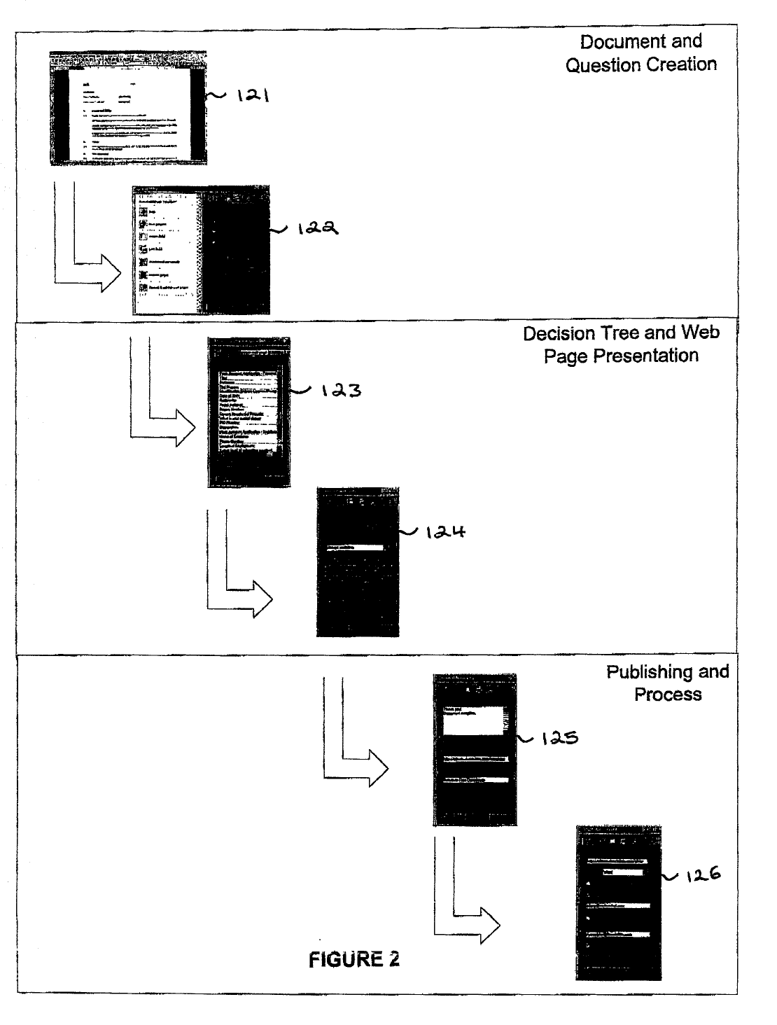

The process for authoring base documents for assembly by subsequent users is indicated in FIG. 2. A word processing document for a particular transaction is created 121, for example using Microsoft WORD, or alternatively an existing WORD document is accessed. The authoring software of the present invention will reside on the author's computer system as a Microsoft WORD add-in. Thus the second stage 122 of the process will be to open the add-in software of the present invention. This converts the WORD document to a special document by changing some of the document attributes. This allows the author to add web controls to the document such as insert free text, insert multi-line text box, numeric values, radio button choices, drop-down menu choices, tick box choices, multi-answer questions, pre-populated text area, lists, dates, and conditional paragraphs.

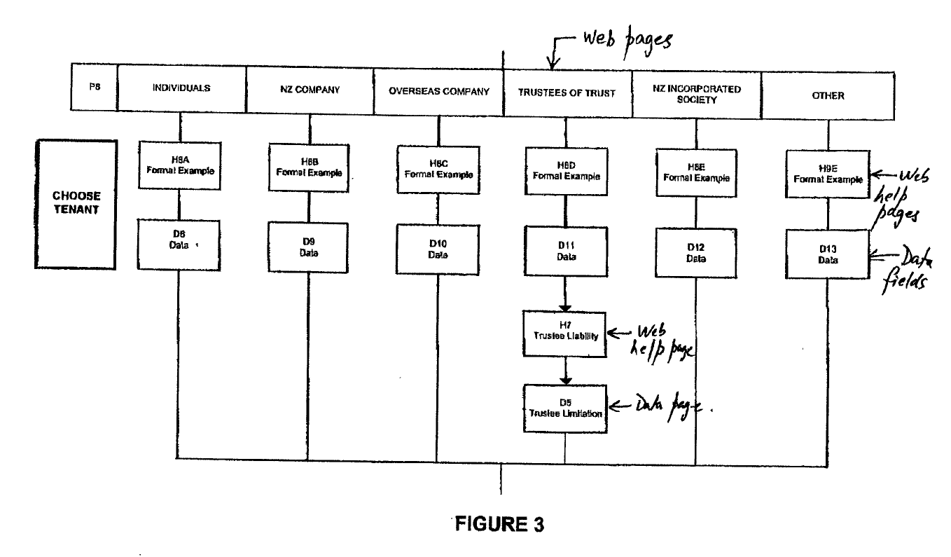

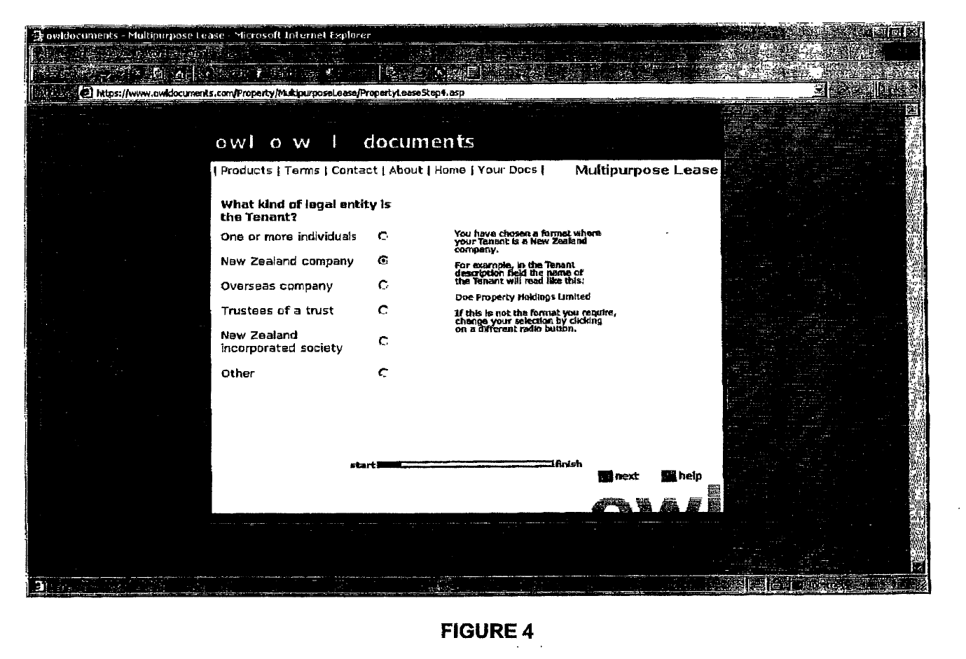

The author must next construct a decision tree to establish the business rules or logic which will determine which document text is to be used in any given assembly of the document in response to answers given by end users. This must be guided by someone expert in field to which the document applies. The author must construct questions appropriate to the logic. The logic takes the form of a decision tree. The length of the decision tree will depend upon the complexity of the document and the total number of possible forms it may take. A tiny fragment of a decision tree for a commercial lease is shown in FIG. 3. This part of the tree solely relates to the choice of the tenant. The author in is case has decided that the tenant may take one of six forms. These are indicated in the row P and the author here has allowed for the tenant to be one of an individual, a New Zealand company, an overseas company, a trustee or trustees, a New Zealand incorporated society or an “other” entity. The author decides that to assist the lay user examples of the format to be used for each of the tenant types should be displayed to the user. These are set out in the H row of FIG. 3 and will in use be placed by the software on the tenant webpage, alongside the selection buttons corresponding to tenant types P as shown in FIG. 4.

The author will then provide data fields for the end user to insert variable data. This is row D in FIG. 3 and in the example this is where the user will be required to insert the name and address of the tenant as shown in FIG. 5. The add-in software marks fields added by the author to the WORD document as merge fields and allocates a unique field ID so that during the assembly process the data captured from the end user in the XML file can be merged in the correct places in the WORD document.

The software of the present invention allows the author to establish and format the document question pages using dialogue box 123 (FIG. 2) based on the decision tree which has been constructed. The question page dialogue may be reviewed, placed on appropriate web pages, etc. The next step 124 provided by the authoring software allows the author to select the look and feel he desires for the webpages presented to the end user, including background colour, font colour and type, and the like.

Next step 125 allows the author to d the notes for the final or “finish” page 125. Here the author will decide what webpage the user is taken to when the document is assembled and select the final action such as email the document to the user or mail a link to the document or provide a webpage with the document link

In step 126 the author determines the format in which the assembled document will be delivered. For example WORD, PDF, RTF, XML, or SOAP. It will also determine where the document is to be delivered, if by email, whether it is an address inserted by the user or a default address.

The final step is for the author to specify the URL of a site running the assembly software where the web pages are to be posted.

Format of Web Pages Created by Authoring Software

The nature of the webpages created by an author using the authoring software of the present invention is shown by way of example in FIGS. 4 to 8. The example is the commercial lease previously referred to. The webpage established by the software in response to the authors decisions entered in step 123 for the tenant are shown in FIGS. 4 and 5. FIG. 4 contains questions as to the type of legal entity of the tenant, allows selection by the end user and provides next to the questions example formats corresponding to those in row H of FIG. 3. The webpage to accept variable data from the user corresponding to name and address of tenant and indicated in row D of FIG. 3 is shown in FIG. 5. Other question pages and data input pages appropriate to a commercial lease and corresponding to the tenant pages already referred to are shown by way of example in FIGS. 6 to 8.

Technical Representation of the Presentation Layer/Business Rules/Data Warehouse

A schematic of the presentation layer/business rules and data warehouse structure is shown in FIG. 9. In the example shown the system is referred to as DOCDOLITTLE™ and the terms used in the schematic are explained in the following appendix.

[image]

[image]

[image]

[image]

1. A document assembly system resident on a web server which allows a user with web connectivity and a browser to invoke said system and interactively assemble a document at the web server comprising:
a stored library of packets of text each relating to a different document and each document packet containing blocks of text that will meet a variety of possible contingencies for a document of that type,
means which dynamically create web pages applicable to a document which present document determining queries to the user's browser and capture decisions made by said user in response, together with unique user input data relevant only to the particular document being assembled,
means which selects from said library blocks of language based on said user decisions,
a database which stores said user data,
software that assembles said blocks of language and populates the assembled document with said user data,
and means for delivering the assembled document to said user.

2. Authoring software for the creation of interactive web pages for a document assembly system resident on a web server comprising:
WP application software which allows the creation of standard text for each of a plurality of documents and which incorporates macros and data fields,
software which includes:
means which creates interactive web pages for said web server,
said pages constructed to in use present document determining queries to a user and capture decisions made by said user in response, together with unique user data input,
means which establish rules for the storage of said user decisions and data input,
means which generate document-specific macros and fields for document text in said WP application, and means which select and trigger appropriate macros based on decisions captured by said web pages and populates appropriate fields with user input data.
